(19) United States
(12) Patent Application Publication
(10) Pub. No.: US 2014/0333779 A1
(43) Pub. Date: Nov. 13, 2014

(54) APPARATUS FOR DISTRIBUTING BUS TRAFFIC OF MULTIPLE CAMERA INPUTS OF AUTOMOTIVE SYSTEM ON CHIP AND AUTOMOTIVE SYSTEM ON CHIP USING THE SAME

(71) Applicant: ELECTRONICS AND TELECOMMUNICATIONS RESEARCH INSTITUTE, Daejeon-city (KR)

(72) Inventor: Kyoung-Seon SHIN, Daejeon (KR)

(73) Assignee: ELECTRONICS AND TELECOMMUNICATIONS RESEARCH INSTITUTE, Daejeon-city (KR)

(21) Appl. No.: 14/255,355

(22) Filed: Apr. 17, 2014

(30) Foreign Application Priority Data
May 13, 2013 (KR) 10-2013-0053597
Dec. 11, 2013 (KR) 10-2013-0153710

(51) Int. Cl. H04N 17/00

(52) U.S. Cl. CPC H04N 17/002; H04N 2201/0001
USPC 348/187

(57) ABSTRACT

An apparatus for distributing the bus traffic of the multiple camera inputs of an automotive system on chip (SoC) and an automotive SoC using the apparatus are disclosed. The plurality of camera data caches stores data from the plurality of cameras in corresponding internal buffers, measures the data storage status of the buffers, and transmits the data to memory. The bus monitor analyzes a bus signal, and then outputs a signal capable of allowing the plurality of camera data caches to transmit the data via the bus based on the results of the analysis. The master arbiter determines the priorities of use of the bus of the camera data caches, and provides the right to use the bus to the plurality of camera data caches based on the priorities of use of the bus.

### CROSS REFERENCE TO RELATED APPLICATIONS

This application claims the benefit of Korean Patent Application Nos. 10-2013-0053597 and 10-2013-0153710, filed on May 13, 2013 and Dec. 11, 2013, respectively, which are hereby incorporated by reference in their entirety into this application.

### BACKGROUND OF THE INVENTION

1. Technical Field

The present invention relates generally to an apparatus for distributing the bus traffic of the multiple camera inputs of an automotive system on chip (SoC) and an automotive SoC using the apparatus and, more particularly, to an apparatus capable of effectively distributing the bus traffic of the multiple camera inputs of an automotive system on chip (SoC), and an automotive SoC using the apparatus.

2. Description of the Related Art

In present day life, automobiles have become daily necessities. Thanks to the development of semiconductor and sensor technology, electronic apparatuses for assisting drivers in more safely and conveniently driving automobiles have been installed in automobiles. Of these electronic apparatuses, advanced driver assistance systems (ADASs) using multiple cameras have been actively developed.

An automotive SoC 20 having multiple cameras, which is used in the above apparatuses, includes one or more camera input devices (that is, camera interfaces 9, 10 and 11), a bus 4, a processor (a central processing unit (CPU)) 5, memory 6, and other peripheral devices, as illustrated in FIG. 1. On the basis of the bus 4, internet protocols (IPs) are classified into master IPs 7 (that is, master IPs having the right to use the one or more camera interfaces 9, 10 and 11, the processor 5, and the bus 4) and slave IPs 8 (that is, slave IPs operating in response to a request from the memory controller 12 and the master IPs 7).

In the operation of the automotive SoC 20, image data input to the camera interfaces 9, 10 and 11 via the external cameras 1, 2 and 3 is written into the memory 6 via the bus 4, and the processor 5 reads the image data from the memory 6, executes a program, such as a detection algorithm, and stores the results of the execution in the peripheral device or memory 6.

A problem of the conventional technology is loss of the image data input from the cameras. That is, the points of time of input and amounts of input data of one or more cameras are different, and thus the traffic of the bus is variable. In particular, if the bus is in busy status when data are simultaneously input from one or more cameras at a specific point of time, the data may be lost without being transferred to the memory.

In the above-described conventional technology, in order to prevent image data input from the cameras from being lost, the highest right to use the bus is provided to the camera input devices of the master IPs that share the bus and the memory. That is, although input image data can be prevented from being lost by providing the camera input devices with a priority higher than that of the processor in the SoC, the memory access of the processor that should execute a primary program in order to frequently process image data is delayed, and thus the overall performance of a system may be deteriorated.

Because of the above problem, a fault may occur in the function of an advanced driver assistance system (ADAS), and thus stability, which is the first priority consideration of an automotive SoC, may be critically influenced.

As a related technology, U.S. Pat. No. 7,127,116 discloses technology in which a camera having an encoder to compress image data compresses an external image, and transmits and stores the compressed external image to and in a main computer via a universal serial bus (USB).

As another related technology, U.S. Pat. No. 5,568,192 discloses technology in which a raw digital signal is captured from a camera and a processor converts the raw video data, transmitted to a computer via a high-speed serial interface and a PCI bus, into a digital video signal and then stores the digital video signal in memory.

### SUMMARY OF THE INVENTION

Accordingly, the present invention has been made keeping in mind the above problems occurring in the conventional art, and an object of the present invention is to provide an apparatus that is capable of determining data transmission time and the amount of data to be transmitted for each of multiple camera input devices by examining the status of a bus and the status of the camera input devices, thereby preventing image data from being lost at the time at which traffic is concentrated and also improving the overall performance of the bus of a system, and to also provide an automotive SoC using the apparatus.

In accordance with an aspect of the present invention, there is provided an apparatus for distributing the bus traffic of the multiple camera inputs of an automotive system on chip (SoC), the apparatus including a plurality of camera data caches configured to store data from the plurality of cameras in corresponding internal buffers, to measure the data storage status of the buffers, and to transmit the data to memory based on the obtained right to use a bus; a bus monitor configured to analyze a bus signal, and to then output a signal capable of allowing the plurality of camera data caches to transmit the data via the bus based on results of the analysis; and a master arbiter configured to, in response to the reception of the signal capable of allowing transmission of the data, determine the priorities of use of the bus of the plurality of camera data caches, and provide the right to use the bus to the plurality of camera data caches based on the priorities of use of the bus.

The master arbiter may determine a camera data cache belonging to the plurality of camera data caches and having lowest remaining buffer capacity to be a camera data cache having a highest priority of use of the bus in response to reception of a transmission enable status signal from the bus monitor.

The master arbiter may provide a transmission stop signal to a camera data cache having the right to use the bus if an emergency situation has occurred.

The bus monitor may analyze the bus signal, and may transmit a transmission enable status signal to the master arbiter when there is no data transmission of the memory so that the plurality of camera data caches can transmit data using the bus.

Each of the plurality of camera data caches may transfer the result of the measurement of the data storage status of its own buffer to the master arbiter.

The result of the measurement of the data storage status of its own buffer may include an empty or full signal or remaining buffer capacity or both.

The transmission of the data to the memory may be performed in burst mode.

In accordance with another aspect of the present invention, there is provided an automotive SoC, including a plurality of camera data caches configured to store data from the plurality of cameras in corresponding internal buffers, to measure the data storage status of the buffers, and to transmit the data to memory based on the obtained right to use a bus; a bus monitor configured to analyze a bus signal, and to then output a signal capable of allowing the plurality of camera data caches to transmit the data via the bus based on results of the analysis; a master arbiter configured to, in response to reception of the signal capable of allowing transmission of the data, determine the priorities of use of the bus of the plurality of camera data caches, and provide the right to use the bus to the plurality of camera data caches based on the priorities of use of the bus; and a processor configured to execute a program stored in memory.

The processor may include cache memory, and may perform an operation of reading data from or writing data into the memory via the bus on a burst basis when there is no data to be used in the cache memory.

The processor may have the highest right to use the bus.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the general configuration of an automotive SoC having multiple cameras; and

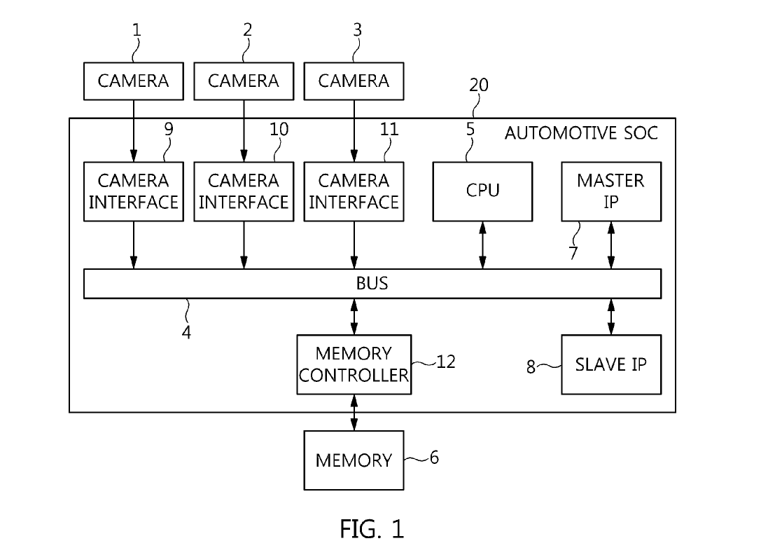

FIG. 2 is a diagram illustrating the configuration of an automotive SoC in which a device for distributing the bus traffic of multiple camera inputs has been employed, according to an embodiment of the present invention.

### DESCRIPTION OF THE PREFERRED EMBODIMENTS

Embodiments of the present invention will be described with reference to the accompanying drawings in order to describe the present invention in detail so that those having ordinary knowledge in the technical field to which the present pertains can easily practice the present invention. It should be noted that same reference numerals are used to designate the same or similar elements throughout the drawings. In the following description of the present invention, detailed descriptions of known functions and constructions which are deemed to make the gist of the present invention obscure will be omitted.

A system on chip (SoC) is a semiconductor that integrates individual semiconductors, such as memory, a processor, software, etc., into a single chip, and is used to control and operate an electronic system. Accordingly, a SoC that is used in an automobile is referred to as an automotive SoC.

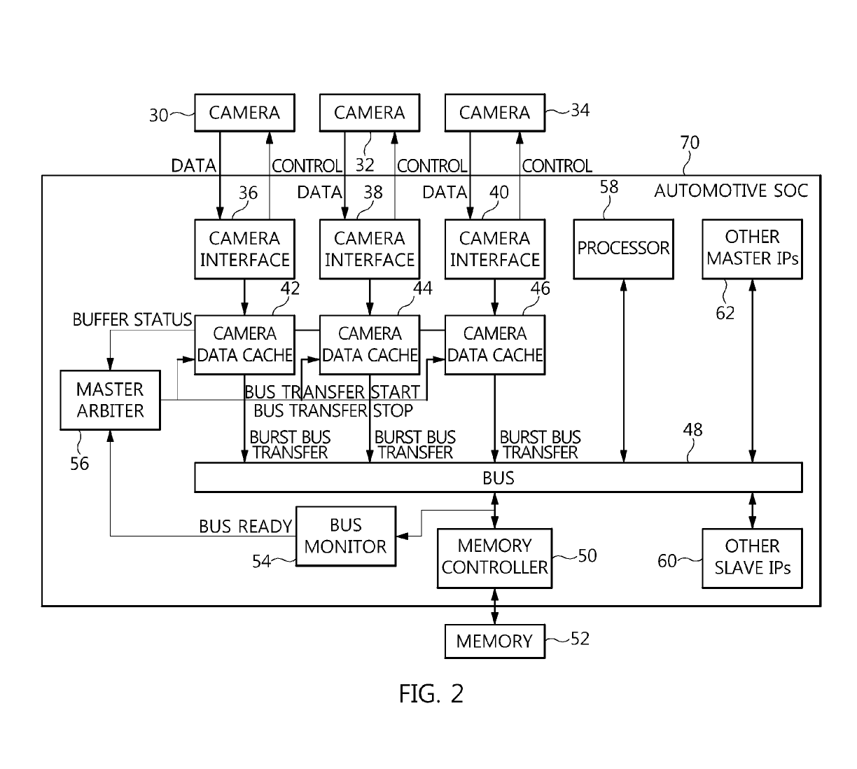

FIG. 2 is a diagram illustrating the configuration of an automotive SoC in which a device for distributing the bus traffic of multiple camera inputs has been employed, according to an embodiment of the present invention.

An automotive SoC 70 illustrated in FIG. 2 includes camera interfaces 36, 38 and 40, camera data caches 42, 44 and 46, a bus 48, a memory controller 50, a bus monitor 54, a master arbiter 56, a processor 58, other slave IPs 60, and other master IPs 62.

The camera interfaces 36, 38 and 40 include data channels adapted to receive image data from external cameras 30, 32 and 34 in real time and control channels adapted to control the cameras 30, 32 and 34. That is, the camera interfaces 36, 38 and 40 may receive image data from the external cameras 30, 32 and 34 via the data channels, and may control the cameras 30, 32 and 34 via the control channels. In this case, the control channels are used for the processor 58 to initialize the respective cameras so that they are suitable for their roles. The data channels are used to receive pixel data generated by the external cameras 30, 32 and 34, together with sink signals, in real time after the cameras have been initialized.

The camera interface 36 performs two-way communication with the camera 30 in a one-to-one correspondence, the camera interface 38 performs two-way communication with the camera 32 in a one-to-one correspondence, and the camera interface 40 performs two-way communication with the camera 34 in a one-to-one correspondence.

The camera data caches 42, 44 and 46 perform the buffer function of storing sequentially pixel data that enter the camera interfaces 36, 38 and 40. Furthermore, the camera data caches 42, 44 and 46 measure the status of buffers (e.g., empty or full, or the remaining capacity of each buffer, or both) attributable to stored pixel data. That is, since the camera data caches 42, 44 and 46 include respective buffers (not illustrated) therein, they may measure the status of the buffers that have stored data. Furthermore, if the camera data caches 42, 44 and 46 obtain the right to use a bus (“bus transfer start”) from the master arbiter 56, the camera data caches 42, 44 and 46 perform the DMA function of transmitting temporarily stored data to primary memory 52 via the bus 48. Basic data transmission to the primary memory 52 is burst transmission, and a transmission unit may be 2, 4, 8, . . . , or 2ⁿ in one of the various modes. Burst operation may be stopped in response to an external request.

The camera data cache 42 is connected to the camera interface 36, the camera data cache 44 is connected to the camera interface 38, and the camera data cache 46 is connected to the camera interface 40.

Although the three cameras, the three camera interfaces and the three camera data caches have been illustrated in FIG. 2, the numbers of cameras, camera interfaces and the camera data caches may be changed as required.

The bus 48 is a transmission channel through which the master IP (for example, the camera interfaces 36, 38 and 40, the camera data caches 42, 44 and 46, the processor 58, etc.) transfers data or a control signal to the shared memory 52 or slave IP.

The memory controller 50 transfers data and a control signal between the bus 48 and the primary memory 52. The memory controller 50 is a general memory controller that has the function of performing interfacing between a bus specification signal and a memory signal.

A predetermined program is stored in the memory 52. Furthermore, data is input to the memory 52, and data is output from the memory 52.

The bus monitor 54 is located near the controller of the shared memory 52 (that is, the memory controller 50). The bus monitor 54 provides notification of transmission enable status (“bus ready”) when there is no data transmission of the memory 52 in response to a request for data transmission from one of the masters (for example, the camera interfaces 36, 38 and 40, the camera data caches 42, 44 and 46, processor 58, the other master IP 62). That is, it is considered that the bus monitor 54 analyzes a bus signal and outputs a signal Bus Ready that enables the camera data caches 42, 44 and 46 to transmit data through the bus 48 based on the results of the analysis.

The master arbiter 56 has the function of determining the priority of use of the bus 48 of the camera data caches 42, 44 and 46. In order to determine the priority of use of the bus 48, when the master arbiter 56 receives a “bus ready” signal from the bus monitor 54, the master arbiter 56 provides “bus transfer start” to a camera data cache that belongs to the camera data caches 42, 44 and 46 and that has the lowest remaining buffer capacity (that is, that will reach a full state most quickly).

Furthermore, if an emergency situation (for example, a case where a camera data cache that becomes full too soon is detected or a case where camera input is stopped by the processor) occurs, the master arbiter 56 may provide a signal capable of immediately stopping transmission “bus transfer stop” to the camera data cache that have provided “bus transfer start” in order to transmit pixel data to the primary memory 52.

The processor 58 sequentially reads instructions stored in the primary memory 52, performs a specific operation in each operation cycle, and uses the results of the specific operation to control a peripheral device. The processor 58 temporarily stores frequently used data in order to reduce the time it takes to read data from the primary memory 52 including cache memory (not illustrated). If there is no data to be used in the cache memory (cache miss), the processor 58 performs an operation of reading data from or writing data into the primary memory 52 on a burst basis via the bus 48. The right to use the bus, which enables the processor 58 to access the primary memory 52, is highest.

The other slave IPs 60 are IPs that have slave functions with respect to a bus that may be required for the configuration of the automotive SoC.

The other master IPs 62 are IPs that have master functions with respect to a bus that may be required for the configuration of the automotive SoC. For example, the other master IPs 62 are IPs that have master functions other than the camera interfaces 36, 38 and 40, the camera data caches 36, 38 and 40, and the processor 58.

The operation of the automotive SoC of FIG. 2 configured as described above will be described below.

The overall operation of the automotive SoC is controlled by the processor 58 that executes the program stored in the primary memory 52.

First, the processor 58 initializes one or more of the external cameras 30, 32 and 34 to be suitable for a purpose at the step of executing an initialization program. In this case, descriptions of the general operations of the automotive SoC having the processor 58 (the initialization and program execution procedures of the memory and each module, etc.) are omitted. The one or more cameras 30, 32 and 34 amounted on the outside of the automotive SoC may be used differently depending on their purposes. For example, if one camera is used for frontal photographing and two cameras are used for lateral photographing, the screen resolution and frame rate (frames per second) of the frontal camera may be set to levels higher than those of the screen resolution and frame rate of the lateral cameras. The processor 58 initializes the cameras 30, 32 and 34 to be suitable for the respective purposes via the control channels of the camera interfaces 36, 38 and 40.

The initialized external cameras 30, 32 and 34 generate a vertical synchronization signal, a horizontal synchronization signal, a pixel clock, and a pixel data in accordance with individual operation modes.

Accordingly, the data channels of the respective camera interfaces 36, 38 and 40 receive pixel data generated by the external cameras 30, 32 and 34 after the initialization of the cameras along with a sink signal in real time.

Furthermore, the camera data caches 42, 44 and 46 connected to the camera interfaces 36, 38 and 40 sequentially store pixel data that enters the camera interfaces 36, 38 and 40.

Thereafter, each of the camera data caches 42, 44 and 46 transfers buffer status (empty or full, or the remaining buffer capacity, or both) attributable to the pixel data to be stored to the master arbiter 56. The reason for this is to enable the master arbiter 56 to determine a camera interface that will be provided with the right to use the bus in order to transmit pixel data by referring to the transferred buffer status.

Furthermore, each of the camera data caches 42, 44 and 46 immediately transmits pixel data to the primary memory 52 when receiving a bus use signal from the master arbiter 56. The transmission to the primary memory 52 is performed using burst mode as basic mode. In this case, each of the camera data caches 42, 44 and 46 determines the amount of data to be transmitted once by checking the remaining buffer capacity. Furthermore, each of the camera data caches 42, 44 and 46 stops burst mode transmission when receiving a transmission stop signal “bus transfer stop” from the master arbiter 56 during the transmission.

The memory controller 50 frequently reads data from or writes data into the primary memory 52 because of the processor 58, the camera data caches 42, 44 and 46 or the other master IPs 62 that share the primary memory 52. In the present invention, the bus monitor 54 analyzes a bus signal between the bus 48 and the memory controller 50, and transfers a bus ready signal to the master arbiter 56 in order to allow the camera data caches 42, 44 and 46 to transmit pixel data using the bus 48 when there is no data transmission to the memory 52.

Thereafter, the master arbiter 56 that has received the buffer status from each of the camera data caches 42, 44 and 46 and the bus ready signal from the bus monitor 54 determines the priorities of use of the bus of the camera data caches 42, 44 and 46. In this case, when the master arbiter 56 receives a signal indicative of transmission enable status “Bus Ready” from the bus monitor 54, the master arbiter 56 determines a camera data cache having the lowest remaining buffer capacity to be a cache having the highest priority by referring to the buffer status of each of the camera data caches 42, 44 and 46, and provides “bus transfer start” to the camera data cache having the highest remaining buffer capacity.

Thereafter, if the buffer of another camera data cache becomes full or transmission is forcibly stopped by the processor 58 while the camera data cache having “bus transfer start” is transmitting pixel data in burst mode, the master arbiter 56 immediately stops transmission by transferring “bus transfer stop” to the camera data cache having “bus transfer start.” This means that the processor 58 has the highest priority of use of the bus. This may enable the opportunity to use the bus to be provided to a camera data cache whose buffer becomes full, and may also enable system efficiency to be improved through the control of the processor 58.

The real-time pixel data input from the cameras 30, 32 and 34 are temporarily stored in the buffers (not illustrated) of the camera data caches 42, 44 and 46 by the above-described operation, the priorities of transmission of the pixel data temporarily stored in the camera data caches 42, 44 and 46 are determined at the time at which the bus 48 is not used, and the pixel data are transferred to the memory 52 and then stored in frame memory for each camera image. Accordingly, the processor 58 may read external image data stored in each of the cameras 30, 32 and 34, may execute a program such as a detection algorithm, and may transfer the results of the execution to a driver via a peripheral device or use the results of the execution to generate a automobile control signal.

In accordance with the present invention configured as described above, in a SoC having multiple camera input devices, the loss of image data at the time at which traffic is concentrated can be prevented by temporarily storing the real-time input pixel data of each of multiple cameras in each camera data cache and then determining the transmission time of the temporarily stored pixel data and the amount of data to be transmitted by examining the bus status of shared memory and the buffer status of each camera data cache.

Furthermore, a higher priority of use of a bus may be provided to the processor than to the camera interface device, and thus the overall performance of the bus of a system can be improved.

When the present invention is employed, it is possible to easily implement ADASs, such as a lane departure warning system, a parking assistance system and a collision avoidance system, using multiple cameras.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for distributing bus traffic of multiple camera inputs of an automotive system on chip (SoC), the apparatus comprising:
a plurality of camera data caches configured to store data from the plurality of cameras in corresponding internal buffers, to measure data storage status of the buffers, and to transmit the data to memory based on obtained right to use a bus;
a bus monitor configured to analyze a bus signal, and to then output a signal capable of allowing the plurality of camera data caches to transmit the data via the bus based on results of the analysis; and
a master arbiter configured to, in response to reception of the signal capable of allowing transmission of the data, determine priorities of use of the bus of the plurality of camera data caches, and provide a right to use the bus to the plurality of camera data caches based on the priorities of use of the bus.

2. The apparatus of claim 1, wherein the master arbiter determines a camera data cache belonging to the plurality of camera data caches and having lowest remaining buffer capacity to be a camera data cache having a highest priority of use of the bus in response to reception of a transmission enable status signal from the bus monitor.

3. The apparatus of claim 1, wherein the master arbiter provides a transmission stop signal to a camera data cache having the right to use the bus if an emergency situation has occurred.

4. The apparatus of claim 1, wherein the bus monitor analyzes the bus signal, and transmits a transmission enable status signal to the master arbiter when there is no data transmission of the memory so that the plurality of camera data caches can transmit data using the bus.

5. The apparatus of claim 1, wherein each of the plurality of camera data caches transfers a result of measurement of data storage status of its own buffer to the master arbiter.

6. The apparatus of claim 5, wherein the result of measurement of data storage status of its own buffer includes an empty or full signal or remaining buffer capacity or both.

7. The apparatus of claim 1, wherein the transmission of the data to the memory is performed in burst mode.

8. An automotive SoC, comprising:
a plurality of camera data caches configured to store data from the plurality of cameras in corresponding internal buffers, to measure data storage status of the buffers, and to transmit the data to memory based on obtained right to use a bus;
a bus monitor configured to analyze a bus signal, and to then output a signal capable of allowing the plurality of camera data caches to transmit the data via the bus based on results of the analysis;
a master arbiter configured to, in response to reception of the signal capable of allowing transmission of the data, determine priorities of use of the bus of the plurality of camera data caches, and provide a right to use the bus to the plurality of camera data caches based on the priorities of use of the bus; and
a processor configured to execute a program stored in memory.

9. The automotive SoC of claim 8, wherein the processor comprises cache memory, and performs an operation of reading data from or writing data into the memory via the bus on a burst basis when there is no data to be used in the cache memory.

10. The automotive SoC of claim 8, wherein the processor has a highest right to use the bus.
